(19) United States
(12) Patent Application Publication
(10) Pub. No.: US 2011/0211637 A1
(43) Pub. Date: Sep. 1, 2011

(54) METHOD AND SYSTEM FOR COMPRESSING DIGITAL VIDEO STREAMS

(75) Inventor: David Frederic Blum, Strasbourg (FR)

(73) Assignee: UB STREAM LTD., Beer Sheva (IL)

(21) Appl. No.: 12/734,724

(22) PCT Filed: Nov. 18, 2008
(86) PCT No.: PCT/IL2008/001512

§ 371 Date: Feb. 9, 2011

Related U.S. Application Data
(60) Provisional application No. 60/996,489, filed on Nov. 20, 2007.

(51) Int. Cl. H04N 7/26

(52) U.S. Cl. 375/240.16; 375/E07.125

(57) ABSTRACT

A video compression method comprises the steps of a) receiving a set of video scenes comprising video frames; b) for each of said video scenes selecting a motion estimation algorithm and/or a rate control algorithm to respectively compress at least two of the scenes, wherein each of said video scenes is encoded by means of a predetermined encoding algorithm; c) carrying out the motion estimation and/or rate control algorithms selection such that the selected motion estimation algorithm provides minimal motion estimation prediction errors and/or the selected rate control algorithm provides the highest quantization factors for the lower distortion; and d) modifying said encoding algorithm for each of said video scenes in order to compress it by means of the selected motion estimation and/or rate control algorithms.

### FIELD OF THE INVENTION

The present invention relates to the compression of video streams to be broadcasted over data networks. More particularly, the invention relates to the optimization of compression of a video encoder used for streaming digital video over a data network.

### BACKGROUND OF THE INVENTION

Transmission bandwidth is an expensive resource in data networks. For example, the transmission of a high-definition video over cable networks consumes a large amount of bandwidth. As another example, transmission of standard definition video over cellular networks, also consumes expensive transmission bandwidth, according to the particular cellular networks capacities. In any cases video transmission has an impact on the quality of other transmissions and more particularly it may be concurrently required by other users for carrying out other tasks. Therefore data compression plays a crucial role in the streaming of media content, such as (but not limited to) video.

Typically, the parties (which are humans or software) involved in the exchange of a video content decide of a common Codec (Coder/Decoder) used for compressing and decompressing said media content and to stream it. These codecs are, for example, the Microsoft technologies WM9 or VC1 (also called SMPTE421M), or the On2 technology VP8. In another approach, a solution known as codecsys (The so-called “Multi-Codec System”) is used by the communicating parties, wherein a multi-codec switch is used to define a suitable Codec for a set of frames. In both solutions there is a wide variety of codecs which may be used and which typically include motion estimation and/or rate control algorithms. When one encoder or a plurality of encoders are used, one can be chosen, which is inadequate for the task at hand. When a multiple codecs approach is used, the most traditional ways of quality evaluation methods of digital video processing systems are based on the computation of the Signal-to-Noise ratio (SNR) and/or Peak Signal-to-Noise Ratio (PSNR), and/or any other approach, which is able to compare the original video signal (encoded) and the signal passed through the system (decoded).

However, PSNR values do not perfectly correlate with a perceived visual quality due to the non-linear behavior of the human visual system, such that compressed video frames having good PSNR values may actually be of substantially poor quality to the viewer's eye. Recently, a number of more complicated and precise metrics were developed, for example UQI, VQM, PEVQ, SSIM and CZD, which are also known in the art as Mean Opinion Score (MOS). These methods are well understood by the skilled person and, therefore, they are not described herein in detail, for the sake of brevity. The performances of an objective video quality metric are evaluated by computing the correlation between the objective scores and the subjective tests results. The most frequently used statistical coefficients are: Pearson's linear correlation coefficient, Spearman's rank correlation coefficient, Kutosis, Kappa coefficient and Outliers Ratio.

When the estimation of the quality of a video codec is done, all the previously mentioned methods may need to repeat post-encoding tests in order to define the encoding parameters, satisfying to the level of visual quality; this is time consuming, complex and impractical for implementation in commercial applications. For this reason, many researches focused on developing novel objective evaluation methods that may enable to predict the perceived quality level of an encoded video.

Due to the difficulties in finding an efficient mathematical approach to evaluate the quality of compressed video signals, video experts often use subjective video quality tests. The main goal of many objective video quality metrics is to automatically estimate the opinion of an average user (viewer) of the quality of a compressed video signal processed by a tested video compression system. However, the simplest way to find out users opinion is to ask directly said users. Nevertheless the subjective measurement of video quality is inaccurate because it requires a trained expert to obtain useful results.

Many subjective video quality measurements are described in ITU-T recommendation BT.500. The ITU-T recommendation is mainly equivalent to the approach proposed in the Mean Opinion Score for an audio media: video sequences are shown to a group of viewers and their opinion is recorded and averaged to evaluate the quality of each video sequence. One of the limitations of this approach is the difference between the specificities of each test.

One of the key elements of many video compression systems is the motion estimation. A video sequence typically consists of a series of frames. In order to achieve compression, the temporal redundancy between adjacent frames can be exploited. More particularly, a frame is selected as a reference, and subsequent sets of frames are predicted from the reference using the motion estimation technique. The process of video compression using motion estimation is also known as interframe coding. In a sequence of frames, a current frame is predicted from a previous frame known as a reference frame. The current frame is divided into macroblocks, typically 16×16 pixels in size. This choice of size is a good trade-off between accuracy and computational cost. However, motion estimation techniques may use different block sizes; the sizes of said blocks can change for each of said frames.

In the motion estimation process, each macroblock is compared to a macroblock of a reference frame using some error measure; the best macroblock match is selected. This search is made over a predetermined search area. A vector denoting the motion (also knows as “motion vector”) of the macroblock, in the reference frame with respect to the macroblock in the current frame is defined.

When a previous frame is used as a reference, the prediction is referred to as a forward prediction. If the reference frame is the next frame, then the prediction is referred as a backward prediction. Backward prediction is typically used with forward prediction, and this is referred to as bi-directional prediction.

For video compression techniques relying on interframe coding, motion estimation is typically one of the most computational intensive tasks. The search process employed in the motion estimation can be modified to be compatible with the specific requirements of an adequate algorithm. Additionally, in many cases, the objects in a scene have large translational movements between a first frame and a second one, since the frames in a video sequence are usually taken at small time intervals. Many techniques have been proposed to solve the problem to determine the best match between a reference frame and a reconstructed frame with the lowest computational cost. Due to the high requirements in reducing the computational costs, many motion estimation algorithms are specialized to specific features of video signals, such as brightness, darkness, fast-motion, or slow-motion scenes.

Some motion estimation methods used nowadays in video broadcasts over data networks commonly attempt to provide high quality reconstructed outputs across a wide range of operating parameters. For example, the Full Search Full Range motion estimation methods have gained widespread acceptance, but it appears that said methods are not suitable to deal with the requests associated with video contents streaming over the Internet or over cellular networks. This is mainly due to the use of the motion estimation algorithm, which is not optimized to all possible scenarios. Motion estimation algorithms are usually designed to efficiently handle a limited set of elements in a sequence of video frames and each algorithm has individual strengths and weaknesses.

The same is true of some of the rate control methods that are used in video streaming over data networks in order to produce high quality reconstructed outputs across a wide range of operation parameters. Some rate control schemes, such as n-pass encoding, have gained widespread acceptance. However, said schemes are usually designed to efficiently handle a limited number of video streams, and they are not completely suitable to handle all kinds of video streams. As with motion estimation, each rate control scheme has its own advantages and weaknesses.

U.S. Pat. No. 6,624,761 discloses a method for carrying out data compression wherein preferable encoders are selected for compressing data blocks belonging to specific data types. However, whenever the data type of a data block is not identified a plurality of encoders are used for concurrently encode the data block and then the output obtained from one of these encoders is used for transmission by choosing the best compression ratio obtained from the encoders.

U.S. Pat. No. 6,421,726 teaches employing a “Smart Mirror” technique in the selection and retrieval of video data from distributed delivery sites. In this system each of the smart mirrors maintains a copy of certain data managed by the system in several alternative file formats and each user is assigned to a specific delivery site based on an analysis of network performance with respect to each of the available delivery sites, wherein the file format is selected based on the capabilities of users terminals.

WO2005/050988 describes a system for compressing portions of a video stream wherein an identification module is used for identifying scenes within the video and a selection module is used for selecting suitable codecs for compressing at least two of the identified scenes according to a set of criteria.

The multi-codecs approach is preferable in video streaming applications in data networks video broadcasting. This approach is costly in view of computation resources and time, due to the need to find the best codec for compressing the streamed-video media, and the need to identify and to characterize a specific set of video frames to be compressed by said codec.

It is an object of the present invention to provide a method and a system for efficiently compressing portions of a video signal using a single codec employing multi-motion estimation and/or multi-rate control mechanisms.

It is another object of the present invention to optimize the performance of video compression systems employing a single selected encoder, wherein algorithms employed by the encoder are defined using an error minimization process.

It is yet another object of the present invention to provide a system and a method for efficiently and quickly compressing video signals and checking compression accuracy without the need for decompression of the compressed video signals and without needing video quality tests in the point of view to compare input uncompress video frame to the Coded/Decoded frame. Further purposes and advantages of this invention will appear as the description proceeds.

### SUMMARY OF THE INVENTION

The invention relates to a video compression method comprising the steps of:
a) receiving a set of video scenes comprising video frames;
b) for each of said video scenes selecting a motion estimation algorithm and/or a rate control algorithm to respectively compress at least two of the scenes, wherein each of said video scenes is encoded by means of a predetermined encoding algorithm;
c) carrying out the motion estimation and/or rate control algorithms selection such that the selected motion estimation algorithm provides minimal motion estimation prediction errors and/or the selected rate control algorithm provides the highest quantization factors for the lower distortion; and
d) modifying said encoding algorithm for each of said video scenes in order to compress it by means of the selected motion estimation and/or rate control algorithms.

According to an embodiment of the invention the video scenes are compressed without exceeding a target data rate and producing the lower distortion for a specific bit rate set, by choosing the rate control algorithm producing the highest quantization factors for said lower distortion. According to another embodiment of the invention the motion estimation algorithm is selected from a set of motion estimation algorithms. The rate control algorithm is selected in one embodiment from a predefined set of algorithms.

According to one embodiment of the invention the selection of the motion estimation method is effected by:
A) processing each frame in a video scene together with a reference frame by a set of motion estimation algorithms to produce a corresponding set of motion vectors;
B) processing each of said motion vectors by constructing a corresponding predicted frame based on said reference frame; and
C) determining which of said predicted frames provides the smallest error with respect to the processed frame.

Determining which of said predicted frames provides the smallest error with respect to the processed frame is done, for instance, according to a Peak Signal to Noise Ratio. In another embodiment determining which of said predicted frames provides the smallest error with respect to the processed frame comprises comparing the minimum error according to a Just Noticeable Difference value.

According to yet another embodiment of the invention the method comprises adjusting the target data rate in response to constraints of the destination system by:
i) adjusting the target data rate in response to conditions of a transmission channel to the destination system;
ii) adjusting the target data rate in response to a message from the destination system;
iii) adjusting the target data rate in response to the lowest distortion;
iv) detecting a change in a scene in response to one frame of the media wherein the signal is different from a previous frame;
v) detecting a change in a scene in response after a fixed period of time without changes in said scene; and
vi) selecting the motion estimation and/or rate control having the least licensing cost in response to two or more motion estimation and/or rate control producing substantially the same quality of compressed output for a scene.

The video compression method of the invention allows to efficiently compress portions of a video signal using a single codec employing multi-motion estimation mechanisms. It also allows to efficiently compress portions of a video signal by means of a single codec employing multi-rate control mechanisms.

A method according to an embodiment of the invention uses and switches between optimized motion estimations algorithms and uses and switches between rate control algorithms for a specific video content in order to provide the highest quality video using a minimum of bandwidth for transmission of said video. Another method uses into an encoder a set of algorithms allowing multiple rate control in order to choose and to switch dynamically between said algorithms for each frame or for each macro block.

According to an embodiment of the invention the method uses into an encoder one motion estimation with different settings. According to another embodiment of the invention the video compression method uses into an encoder one rate control with different settings.

All the above and other characteristics and advantages of the invention will be further understood through the following illustrative and non-limitative description of preferred embodiments thereof, with reference to the appended drawings, wherein identical components are designated by the same reference numerals.

### BRIEF DESCRIPTION OF THE DRAWINGS

FIG. 1 is an example of a block diagram illustrating a multi-motion estimation approach employed in the present invention;

FIG. 2 is an example of a block diagram illustrating a multi-rate control approach employed in the present invention;

FIG. 3 is an example of a block diagram illustrating an embodiment of the invention embedding the multi motion estimation and multi rate control techniques of the invention;

FIG. 4 is an example of a block diagram illustrating an implementation of a unit employed in order to choose the best motion estimation algorithm for the video compressor of the present invention; and

FIG. 5 is an example of a block diagram illustrating a possible implementation of a unit employed in order to choose the best rate algorithm in the video compressor of the invention.

### DETAILED DESCRIPTION OF THE INVENTION

The present invention provides a method to optimize the compression done by video encoders and including motion estimation and/or rate control. Said motion estimation and said rate control mechanisms are responsible for a part of the bandwidth usage and of the quality of the compressed video transmitted.

The present invention provides a new compression method finding for each frame, and/or for each macroblock within a frame, the optimal configuration, to obtain the best results from the employed motion estimation and/or rate control schemes. In an embodiment of the present invention:
the most appropriate motion estimation scheme used for a specific frame, or sequence of frames, is defined using a library of motion estimation algorithms, and/or
the most appropriate rate control scheme used for the same specific frame, or sequence of frames, is defined from a library of rate control algorithms.

According to another embodiment of the present invention, the selection of the most appropriate motion estimation and/or rate control algorithms is rendered significantly accurate according to the distinction between these two elements, allowing to define the expected results from each of them. More particularly, the expectation of the motion estimation algorithm employed are accurate frame reconstructions oriented, and the expectation of the rate control module results is based on the highest quantization factors per frame and/or macroblock. The use of a mathematical approach for minimizing frame prediction errors allows the system of the present invention to automatically select the optimal motion estimation algorithm and/or rate control to be used for the compression of a set of frames in a video stream.

According to yet another embodiment of the present invention, the method uses and switches between optimized motion estimation algorithms for specific parameters of a video content, such as brightness, darkness, fast-motion, or slow-motion scenes. Said use and switch between said motion estimations algorithms results in a high quality of streamed videos needing a low bandwidth by switching frame by frame between one motion estimation algorithm to another and/or by switching frame by frame between one rate control algorithm to another.

According still another embodiment of the present invention, the compression efficiency and quality are optimized by concurrently testing a number of motion estimations and/or rate control schemes with a set of frames, and selecting the motion estimations and/or rate control schemes used for the compression of said set of frames doing the comparison of the frames obtained from a reconstruction of the outputs issuing from the motion estimation computation and/or rate control schemes against the original set of frames. In other word, in the video compression process done by this embodiment of the present invention, the motion estimation and/or rate control algorithms used for optimizing said compression accuracy are defined before compressing a sequence of frames, such that the optimization process does not require a decoding step, as done in the prior art, and it does not attempt to define the quality of the compressed frames.

During the reconstruction of the frames according to the outputs obtained from the motion estimation algorithm used, the reference frame is used to predict the current frame by calculated means of the motion vectors. This method is known as motion compensation. During said motion compensation, the macroblock in the reference frame, which is referenced by the motion vector, is duplicated in the reconstructed frame. The frame-by-frame determination of the best motion estimation used is based on the better prediction of the current frame; namely, the motion estimation algorithm used by the video compressing system of the present invention is the algorithm minimizing the error between the current frame and the reconstructed frame. Since, this approach allows finding the smallest difference between the reconstructed frame and the reference frame the transmission bandwidths of the compressed content, said difference decreases and the best transmission quality is obtained.

A motion estimation algorithm can be mainly evaluated in view of one or more of the following factors:
capability to produce displacement estimation with high spatial resolution;
capability to handle with motion discontinuities and the occlusion problem;
sensitivity to the noise in the data;
accuracy of the displacement estimation;
minimization of the energy of displaced frame difference image;
reduction of the entropy of the resulting displaced frame difference image; and
spatial uniformity of the displacement vector field.

Ideally, it is necessary to have displacement estimates responding to all of said factors. However, some of these factors may or may not be important according to the nature of the application using said displacement estimates. As an example, the accuracy of displacement estimates is highly important in applications such as motion compensated frame interpolation.

In order to define which motion estimation algorithm should be used, the Signal-to-Noise ratio (SNR) or Peak Signal-to-Noise ratio (PSNR) or Just Noticeable Difference (JND) value, is calculated between the original video signal and the signal passed through the system (i.e., motion estimation and motion compensation). PSNR is the most widely used objective video quality metric and allows finding which of the motion estimations provides the best frame reconstruction. In an embodiment of the invention an encoder (such as H.264 encoder or MPEG4) is used to compress a streamed video. Said encoder is chosen by finding an encoder able to provide the most optimal results at a specific rate. The encoder used in the compression system of the present invention is an encoder able to provide the best results, and which could be a standard encoder.

According to yet another embodiment of the present invention, the chosen encoder is modified by embedding into said encoder, a multi-motion estimation and/or multi rate control. Said multi-motion estimation and/or multi rate control define mechanisms used in order to define the most accurate motion estimation algorithm and/or multi rate control algorithm used to encode each frame. Said encoder is chosen using results of a set of visual tests performed between standard codecs, in order to define which one produces the best visual quality. As another example, the H.264 codec is considered as a good candidate, but in order to choose a preferable encoder, visual tests are first performed.

Rate-distortion (R-D) analysis and rate control play a key role in video encoding and communication systems. Optimized Rate-Distortion compression performance assures successful network transmission of the encoded video data, and achieving the best visual quality at the receiver. In conventional R-D analysis, the bit rate R and distortion D are considered as functions of a quantization parameter q. Thus, source models are developed in a q-domain. These source models have very high computational complexity, and suffer from relatively large estimation and a poor control error. The system of the present invention uses and switches between rate control algorithms for specific video content, such as brightness, darkness, fast-motion, or slow-motion scenes, allowing to provide the highest quality video at the lowest possible use of the bandwidth during data transmission, by switching frame by frame between one rate control algorithm to another.

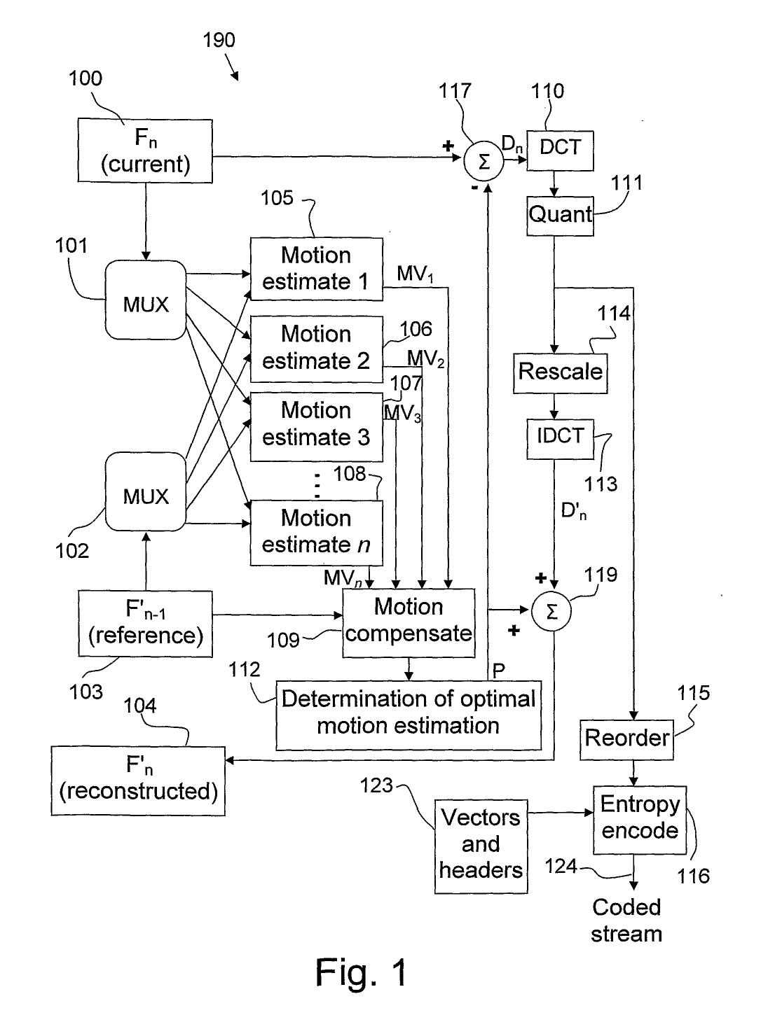

FIG. 1 is a block diagram showing an embodiment of the present invention of a video compressor 190 wherein a multi-motion estimation approach is employed. Said Video compressor 190 receives a frame Fₙ 100 as an input for encoding, which is preferably processed therein in macroblock units (e.g. corresponding to a luma region and associated chroma samples). Video compressor 190 comprises a set of motions estimators (Motion estimate 1, 2, 3, . . . , n) 105, 106, 107 and 108. Each motions estimator receives as an input said frame Fₙ100 and a previous frame Fₙ₋₁ (a reference frame) 103 via the multiplexers 101 and 102, respectively. Motions estimators 105, 106, 107 and 108, finds macroblock regions in reference frame Fₙ₋₁ 103 (or in a sub-sample interpolated version F′ₙ₋₁) matching macroblocks in input frame Fₙ 100 (e.g, based on a similarity matching criteria). The offsets between the locations of said macroblocks in the current frame 100 and in the reference frame 103 are used for constructing a motion vector MV, such that motion vectors MV₁, MV₂, MV₃, . . . , MVₙ are respectively obtained from each motion estimation unit 105, 106, 107, . . . and 108.

Each of the motion vectors MV₁, MV₂, MV₃, . . . , MVₙ, is then processed by a motion compensation unit 109, which receives reference frame Fₙ₋₁ (103) as an input that is used therein for reconstructing from each motion vector a corresponding reconstructed frame. In unit 112 the optimal motion estimation algorithm is determined based on comparison between the reconstructed frames and current frame Fₙ 100. The optimal motion estimation algorithm is chosen from a group of motions estimation algorithms, such as, but not limited to, Block Matching, Hierarchical Block Matching, Phase Correlation, Netravali-Robbins Algorithm, Diamond search, Hexagonal. Based on the chosen motion vector MV, a motion compensated prediction frame P is generated. In summation unit 117 motion compensated prediction frame P is subtracted from the input frame Fₙ (100) to produce a residual or difference frame Dₙ.

The macroblocks in difference frame Dₙ are transformed using discrete cosine transformation in DCT unit 110, and thereafter each sub-block is quantized in quantization unit 111. The DCT 110 coefficients of each sub-block are reordered in Reorder Unit 115 and run-level coded. Finally, the DCT coefficients, the selected motion vector and the associated packet header information for each macroblock are entropy encoded in encoder 116 to produce the compressed bit stream 124 for transmission.

The reconstruction process of the data flow is carried out as follows. Each quantized macroblock is resealed in rescale unit 114, and inverse transformed in the Inverse Discrete Cosine Transform (IDCT) unit 113, to produce a decoded residual D′ₙ. It is noted that due to the nonreversible quantization process carried out in quantization unit 111, D′ₙ and Dₙ are not identical since distortion is introduced by the quantization process.

It should be understood that this is only one example demonstrating how to integrate the multi-motion estimation and/or multi rate control determining approach of the invention into an exemplary encoder. The same (or modified) mechanism may be incorporated into an H.264 encoder, for example, that uses intra and inter encoding, or as another example, into an mpeg-4 encoder. The modifications required for incorporating the multi-motion estimation and/or multi-rate control determining mechanism of the invention into different types of encoders are within ordinary skills of man of the art in video encoding, and thus can be easily performed without requiring significant efforts.

In summation unit 119 the motion compensated prediction P is added to the decoded residual D′ₙ to produce a reconstructed macroblock, which is stored in a reconstructed frame buffer 104, F′ₙ to be used as a reference frame 103 for the next input frame 100.

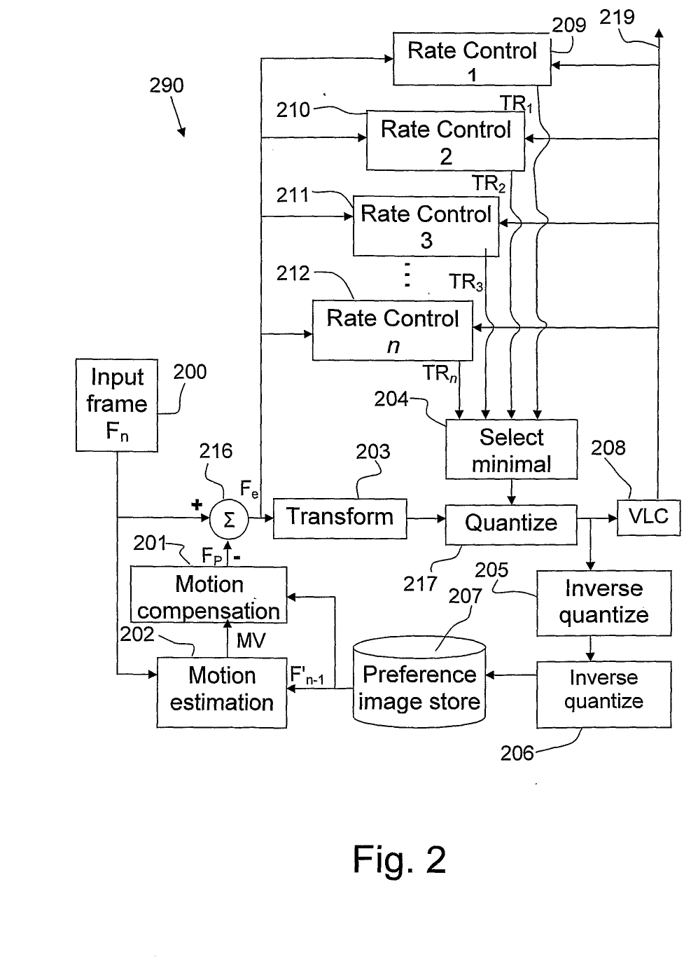

FIG. 2 is a block diagram showing an embodiment of a video compressor 290 utilizing the multi rate control approach of the invention. An input frame Fₙ 200 received in video compressor 290 is first processed in motion estimation unit 202, which also receives a reference frame Fₙ₋₁ from memory storage 207. Frames Fₙ and Fₙ₋₁ are processed by motion estimation unit 202 which produces a corresponding motion vector MV selecting motion estimation algorithm. The motion vector MV and the reference frame Fₙ₋₁ are processed in motion compensation unit 201 which generates a motion compensated prediction frame F_{P}. In summation unit 216 motion compensated prediction frame F_{P} is subtracted from the input frame Fₙ 200 which results in a frame prediction error signal Fₑ.

Frame prediction error signal Fₑ is then concurrently processed by DCT transformer 203, and by rate control units 209, 210, 210, . . . and 212, which utilize the encoder output 219 for determining a possible transmission rate (TR) by means of different rate control algorithms (Rate control 1, 2, 3, and n). The transmission rates TR₁, TR₂, TR₃, . . . and TRₙ, obtained from rate control units 209, 210, 210, and 212, are received in quantization selection unit 204, which determines a rate control unit to be used for the encoding, such that the selected transmission rate in the one having the optimal quantization. For example, for each processed Macroblock/Frame the rate control chosen is the one capable of providing less distortion and higher quantization Factor, or higher matrix quantization. The output of quantization selection unit 204 is then used by the quantization unit 217 in the quantization of the DCT transformation of frame prediction error signal Fₑ received from DCT transformer 203. The quantized frame produced by quantization unit 217 is then provided to a variable length coding (VLC) 208, which output is the compressed video output of video compressor 290.

The output of quantization selection unit 204 is also processed by an inverse quantization unit 205, the output of which is processed by inverse IDCT block transformer 206. The frame produced by the IDCT block transformer 206 is then stored in memory 207, and thereafter used as a reference frame F′ₙ₋₁ for the next input frame Fₙ.

Each of the motion vectors MV₁, MV₂, and MVₙ, is then processed by a corresponding motion compensating unit 202a, 202b, . . . and 202c, to produce a corresponding set of compensated prediction frames F_{P1}, F_{P2}, . . . and F_{Pn}. A set of summation units 216a, 216b, . . . 216n, are used for subtracting the compensated prediction frames F_{P1}, F_{P2}, and F_{P}, from input frame 300 (Fₙ), and produce a set of residual (or difference) frames Dₙ₁, Dₙ₂, . . . and Dₙₙ. Unit 214 receives residual frames Dₙ₁, Dₙ₂, and Dₙₙ, and determines which of the motion estimation units 202a, 202b, . . . or 202c produced a motion vector which compensated prediction frame (F_{P}) provides the minimal error.

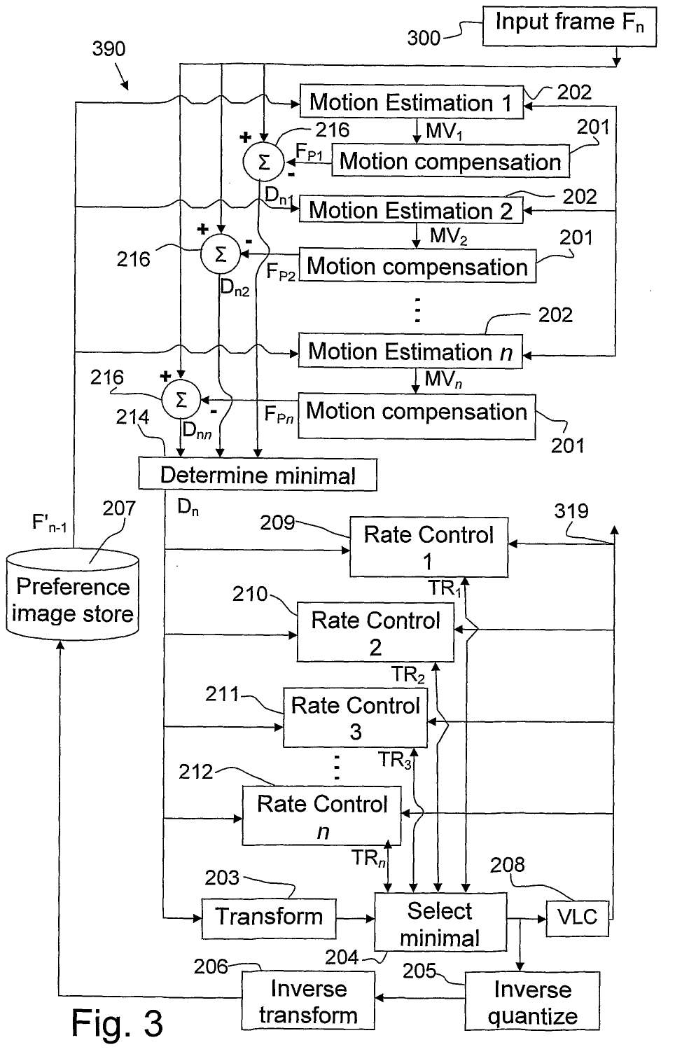

FIG. 3 is a block diagram illustrating an embodiment of video compressor 390 in which the multi motion estimation and the multi rate control techniques of the invention are employed. In this embodiment the input frame Fₙ 300 to be communicated to a destination system (not shown), and a reference input frame F′ₙ₋₁ received from a memory storage 207, are processed by a set of motion compensation units 202a, 202b, and 202c, in which different motion estimation algorithms (Motion estimation 1, 2, n) 202a, 202b, 202c are used for producing motion vectors MV_{I}, MV₂, and MVₙ.

The residual frame Dₙ received from the motion estimation which provided the best reconstructed frame, as produced by unit 214, is concurrently processed by DCT transformation unit 203 and by a set of rate control units 209, 210, 211, . . . and 212, which produce a corresponding set of possible transmission rates TR₁, TR₂, TR₃, and TRₙ. The DCT transformation produced by transform unit 203, and the transmission rates TR_{I}, TR₂, TR₃, TRₙ, are received in a selection unit 204 which determines which of the transmission rates TR_{I}, TR₂, TR₃, TRₙ, provide the minimal quantization. The output of selection unit 204 is received by variable length coder (VLC) 208, which produces the compressed video output 319 of video compressor 390.

The output of selection unit 204 is also passed through inverse quantization unit 205, and which output is then passed through IDCT transform unit 206, in order to produce a new reference frame F′_{N-1}, which is stored in memory 207.

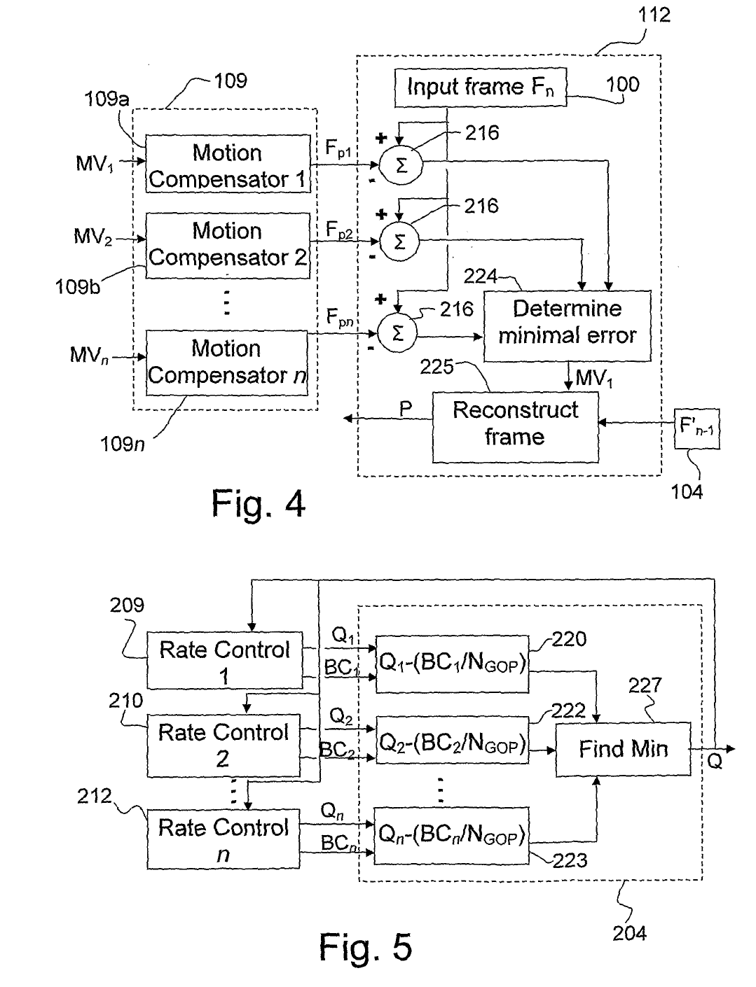

FIG. 4 is a block diagram demonstrating a possible implementation of a unit 112 employed for choosing the best motion estimation algorithm in the video compressor of the invention. In this example each of the motion vectors MV₁, MV₂, and MVₙ, is processed by a corresponding motion compensator unit 109a, 109b, . . . 109n, which produce a corresponding set of compensated prediction frames F_{P1}, F_{P2}, and F_{Pn}. In determining unit 112 each of these compensated prediction frames F_{P1}, F_{P2}, and F_{Pn} is compared with the input frame 100 by means of a respective summation unit 216a, 216b, 216n, and the comparison results are then processed by minimal error determining unit 224. In general, the comparison result of minimal error is the one which is closer to zero, which may be determined by, for example, PSNR. Based on the selected motion estimation, as produced by unit 224, frame reconstruction of reference frame F′ₙ₋₁ 104 is performed in frame reconstruction unit 225, which results in the reconstructed frame P.

FIG. 5 is a block diagram showing a possible implementation of a unit 204 for choosing the best rate control algorithm in the video compressor of the invention. In this example, the rate control selection unit 204 receives from each rate control 209, 210 and 212 its quantization result and the respective buffer capacity, (Q₁, BC₁), (Q₂, BC₂), . . . , (Qₙ, BCₙ), which are used by to determine corresponding optimizing parameters in units 220, 221 and 222. These optimization parameters are then compared by comparator unit 227, which is used for determining the minimal optimization parameter, such that the quantization result for which the minimal optimization parameter is obtained is used by the system in the compression of the current frame, or current group of frames.

As an example shown in FIG. 5, the optimization parameter is the result of subtracting the ratio between the buffer capacity and the number of frames in the GOP (group of frames) from the quantization result (q-BC/N_{GOP}). While this criterion for determining optimal rate control quantization can provide good results, it should be clear that other criteria may be used.

As still a further embodiment of the present invention, the motion estimation and/or rate control algorithms are automatically selected to produce the highest compression quality for the respective scenes according to a set of criteria without exceeding a target data rate. The compression module Encoder 208 compresses the scenes using the automatically selected motion estimation and/or rate control algorithms, after which the compressed scenes are delivered to the destination system (not shown).

Although embodiments of the invention have been described by way of illustration, it will be understood that the invention may be carried out with many variations, modifications, and adaptations, without exceeding the scope of the claims.

1. A video compression method comprising:
receiving an input video frame divisable into plural input macrob locks;
providing each input macroblock to a set of motion estimators;
for each input macroblock, selecting the output of a motion estimator which provides minimal motion estimation prediction errors for said input macroblock; and
using the per block, motion estimation output for encoding said input video frame.

2. The method according to claim 1, wherein said set of motion estimators implement different motion estimation algorithms.

3. The method according to claim 1, wherein said set of motion estimators implement the same motion estimation algorithm with different parameters.

4. The method according to claim 2, and wherein said using comprises generating a prediction frame from output of different ones of said set of motion estimators.

5. The method according to claim 4, wherein said using comprises generating a reference frame for the next input frame from said prediction frame.

6. The method according to claim 2, wherein said selecting is independent of a data rate, a frame rate and/or a frame size.

7. The method according to claim 2, wherein said selecting comprises:
generating a motion compensated, prediction macro-block for the output of each motion estimator;
subtracting each said prediction macro-block from said input macro-block to generate prediction error macro-blocks; and
determining which prediction error macro-block has the lowest error.

8. A video compression method comprising:
receiving an input video frame divisable into plural input macrob locks;
providing each input macroblock to a set of rate control units;
for each input macroblock, selecting the output of a rate control unit which provides highest quantization factors for the lowest distortion for said input macroblock; and
using the per block, rate control output for encoding said input video frame.

9. The method according to claim 8 and wherein each rate control unit has a different rate-distortion model.

10. The method according to claim 8 and wherein said using comprises quantizing said input frame from output of different ones of said set of rate control units.

11. The method according to claim 8 and also comprising updating each said rate control unit with the rate generated by said selected rate control unit.

12. A video compression method comprising:
receiving an input video frame;
providing said input video frame to a set of rate control units;
for each input frame, selecting the output of a rate control unit which provides highest quantization factors for the lowest distortion for said input frame; and
using the per frame, rate control output for encoding said input video frame.

13. The method according to claim 12 and wherein each rate control unit has a different rate-distortion model.

14. The method according to claim 12 and wherein said using comprises quantizing said input frame from output of said selected rate control unit.

15. The method according to claim 12 and also comprising updating each said rate control unit with the rate generated by said selected rate control unit.

16. A video compression unit comprising:
a divider to divide an input video frame into plural input macroblocks;
a set of motion estimators each receiving the same input macroblock;
a selector to select, for each input macroblock, the output of a motion estimator which provides minimal motion estimation prediction errors for said input macroblock; and
an encoder to use the per block, motion estimation output for encoding said input video frame.

17. The unit according to claim 16, wherein said set of motion estimators implement different motion estimation algorithms.

18. The unit according to claim 16, wherein said set of motion estimators implement the same motion estimation algorithm with different parameters.

19. The unit according to claim 17, and wherein said encoder comprises a prediction frame generator to generate a prediction frame from output of different ones of said set of motion estimators.

20. The unit according to claim 19, wherein said encoder comprises a reference frame generator to generate a reference frame for the next input frame from said prediction frame.

21. The unit according to claim 17, wherein said selector operates independent of a data rate, a frame rate and/or a frame size.

22. The unit according to claim 17, wherein said selector comprises:
a macro-block generator to generate a motion compensated, prediction macro-block for the output of each motion estimator;
a subtractor to subtract each said prediction macro-block from said input macro-block to generate prediction error macro-blocks; and
a selector to determine which prediction error macro-block has the lowest error.

23. A video compression unit comprising the steps of:
a divider to divide an input video frame into plural input macrob locks;
a set of rate control units each receiving the same input macroblock;
a selector to select, for each input macroblock, the output of a rate control unit which provides highest quantization factors for the lowest distortion for said input macroblock; and
an encoder to use the per block, rate control output for encoding said input video frame.

24. The unit according to claim 23 and wherein each rate control unit has a different rate-distortion model.

25. The unit according to claim 23 and wherein said encoder comprises a quantizer to quantize said input frame from output of different ones of said set of rate control units.

26. The unit according to claim 23 and also comprising an updater to update each said rate control unit with the rate generated by said selected rate control unit.

27. A video compression unit comprising:
a set of rate control units each to receive an input video frame;
a selector to select, for each input frame, the output of a rate control unit which provides highest quantization factors for the lowest distortion for said input frame; and
an encoder to use the per frame, rate control output for encoding said input video frame.

28. The unit according to claim 27 and wherein each rate control unit has a different rate-distortion model.

29. The unit according to claim 27 and wherein said encoder comprises a quantizer to quantize said input frame from output of said selected rate control unit.

30. The unit according to claim 27 and also comprising an updater to update each said rate control unit with the rate generated by said selected rate control unit.
